(19) United States
(12) Patent Application Publication
(10) Pub. No.: US 2008/0277236 A1
(43) Pub. Date: Nov. 13, 2008

(54) Parking Brake System

(76) Inventors: Uwe Ruhringer, Tettnang (DE); Wolfgang Schmid, Langanargen (DE); Thilo Schmidt, Meckenbeuren (DE)

Correspondence Address: DAVIS BUJOLD & Daniels, P.L.L.C., 112 PLEASANT STREET, CONCORD, NH, 03301, US

(21) Appl. No.: 11/629,428

(22) PCT Filed: Jun. 4, 2005
(86) PCT No.: PCT/EP05/06026

§ 371 Date: Dec. 13, 2006

(30) Foreign Application Priority Data
Jun. 22, 2004 (DE) 10 2004 030 006.2

(51) Int. Cl. B60W 10/18

(52) U.S. Cl. 192/219.6

(57) ABSTRACT

A parking lock device for the power train of motor vehicles with automatic transmissions having an actuator and a locking mechanism that is operated by the actuator. A power take-off of the power train locked in a closed condition by the locking mechanism and is free to rotatable in open condition by the locking mechanism. The locking mechanism may be engaged by pressurizing a piston unit of the actuator in a locking direction and may be held in a disengaged condition by a snap-in locking device controlled by an electromagnetic actuator. The snap-in locking device may be deactivated by the electromagnetic actuator. The locking mechanism may be engaged with an emergency locking device and opened with an emergency unlocking device and activated with a common actuator mechanism so that manual activation of the actuator mechanism alternatively disengages or engages the locking mechanism.

The present invention relates to a parking lock device for the power train of an automatic transmission for motor vehicles as described in the preamble of claim 1.

From DE 198 34 156 A1, a parking lock device for motor vehicles is known, which may be disengaged by hydraulic pressure. This device is kept disengaged by a locking mechanism, whereby the power take-off of the vehicle is freely mobile. The locking mechanism is operated by energizing an electromagnet. If the electromagnet is de-energized, the parking lock device no longer remains disengaged and a pawl engages in a parking gear wheel of the parking lock device, whereby the power take-off is secured against rotation.

The disadvantage, however, is that in case of system failures, which block the power take-off of the vehicle in this default position, because neither hydraulic pressure to disengage the engaged parking lock device, nor power to maintain the parking lock device in its engaged or disengaged position are available, the parking lock device cannot be deactivated by the driver in order, for example, to take it to a car repair shop.

From DE 43 17 257 C1, a parking lock device for automatic transmission for motor vehicles is known, whereby the automatic transmission is blocked or released by a signal from a control device activated by the driver. In addition, the parking lock device has a mechanical emergency unlocking mechanism by way of which the parking lock device, operated hydraulically under normal operating conditions, can be unlocked manually by the driver with a mechanical actuator. A lock bar of the mechanical actuator and/or the mechanical emergency unlocking device is controlled with a connecting rod located in a guide groove.

The disadvantage, however, is that integration of the emergency unlocking device, proposed in DE 43 17 257 C1 in basically known parking lock devices, is hardly feasible because of the large space required for the emergency unlocking device.

Additionally disadvantageous is that the parking lock device, disengaged by way of the emergency unlocking device, cannot be locked again by the driver if necessary, whereby the vehicle can no longer be secured by the parking lock device without hydraulic pressure against an unintended rolling away after the emergency unlocking of the parking lock device.

DE 198 48 733 A1 discloses a parking lock device whereby, in case of system failures, the device can be unlocked manually, if necessary, by the driver and/or operator with an emergency unlocking device or is locked again with an emergency locking device that returns the power take-off to its blocked position. For this purpose, the parking lock device of the automatic transmission is unlocked at the automatic transmission by activating a towing device accessible from outside the motor vehicle and the related axial movement of the operating connection between the towing device and the emergency unlocking device. By stopping the towing device, the unlocking device remains activated until the towing device is manually reactivated by an operator.

However, the disadvantage of this parking lock device is that the actuator mechanism for the emergency locking device and emergency unlocking device cooperating with the towing device is arranged outside the vehicle so that the operator and/or the driver must get out of the vehicle to operate the parking lock device.

It is furthermore disadvantageous that the towing device may potentially be damaged by unacceptably high tractive force applied to the towing device during towing so that the emergency locking device and emergency unlocking device can no longer be controlled as desired with the actuator mechanism of the towing device.

The aim of the present invention is, therefore, to propose a parking lock device which may be easily activated and deactivated by an operator and requires a small installation space.

According to the present invention, this problem is solved by a parking lock device characterized in patent claim 1.

According to the present invention, the parking lock device for the power train of a motor vehicle with automatic transmission comprises a locking mechanism that can be operated by an actuator, whereby the power take-off is kept loved in an engaged condition and rotatable when the locking mechanism is in disengaged condition. The locking mechanism may be disengaged in the normal mode of operation of the motor vehicle by pressurizing a piston unit of the actuator with a fluid against a spring device engaged in the piston unit in the locking direction of the locking mechanism, and is held in the disengaged condition by an electromagnetic actuator controlled by a snap-in locking device that fixes the piston unit in an activated condition in axial position equivalent to the disengaged condition of the locking mechanism, whereby the snap-in locking device may be deactivated manually with the electromagnetic actuator. The locking mechanism can be engaged manually with an emergency locking device, and disengaged with an emergency unlocking device, and may advantageously be deactivated and activated by an operator, and is characterized by requiring a small installation space.

This is achieved by activating both the emergency unlocking device and the emergency locking device by way of a common actuator so that manual operation of the actuator mechanism in the same operating direction alternatively disengages or engages the locking mechanism.

This means that every manual operation of the actuator mechanism changes the existing position of the parking lock device, and the intuitive operation of the emergency unlocking device and emergency locking device by the driver may be performed in the same way with a single actuator mechanism requiring a small installation space.

An actuator mechanism arranged this way may, for instance, be easily mounted in the passenger compartment to allow manual operation of the parking lock device by the driver from the driver's seat without having to release the brake pedal, which can potentially be advantageous, if the emergency brakes were to fail on a slope.

Further advantageous developments of the subject matter of the present invention result from the embodiment of the invention disclosed in principle in the patent claims and from making reference to the drawings. The drawings show:

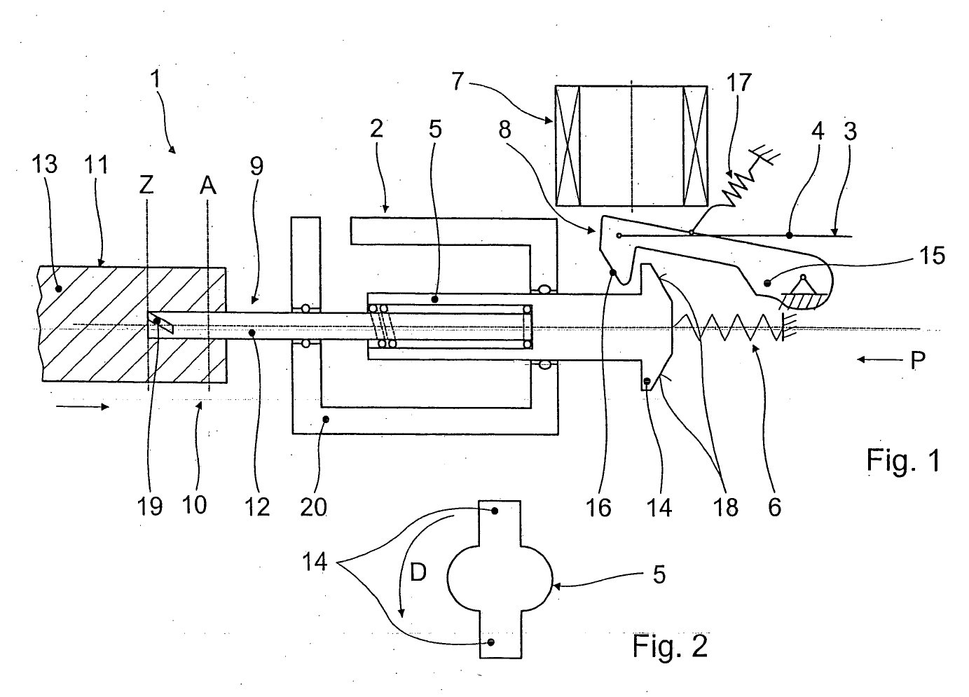

FIG. 1 is a general outline of the embodiment of a part of the parking lock device, according to the present invention, and

FIG. 2 is a schematic illustration of the front view of the piston unit of the parking lock device, according to FIG. 1.

FIG. 1 shows an outline of a part of parking lock device 1 for the power train of an automatic transmission of motor vehicles. The parking lock device 1 comprises an actuator 2 and a locking mechanism 3 that can be activated by the actuator 2 of which only a parking lock device rod 4 is illustrated in the drawing. The parking rod 4 is functionally connected to a parking lock device pawl arranged in the basically known way, which can be engaged with a parking lock device wheel connected to the power take-off of the motor vehicle in such a way that the power take-off can be secured by the parking lock device pawl against undesired rotation. This means that the power take-off of the power train is kept rotationally locked in an engaged condition by the locking mechanism 3, and that it may rotate when the locking mechanism is in disengaged condition and the parking lock device pawl is not engaged in the parking lock device wheel.

In the normal operating mode of the motor vehicle the locking mechanism can be disengaged by pressurizing a piston unit of the actuator 2 with a fluid against a spring device 6 engaged in a piston unit 5 in direction of the locking mechanism. Further, the locking mechanism 3 is kept disengaged by an electromagnetic actuator 7 controlled by a snap-in locking device 8 that fixes the piston unit 5 in activated condition in an axial position equivalent to the disengaged condition of the locking mechanism 3, whereby the snap-in locking device 8 may be deactivated via the electromagnetic actuator 7 in the way that will be described below.

The locking mechanism 3 may be locked manually by an operator with an emergency locking device 9, and disengaged manually with an emergency unlocking device 10, whereby the emergency unlocking device 10 and the emergency locking device 9 can be operated with a common actuator mechanism 11 so that manual operation of the actuator mechanism 11, such as pressing to alternatively disengage or engage the locking mechanism, is performed by the same locking mechanism 3.

In the present invention, the actuator mechanism 11 discloses a piston rod 12 connected to the piston unit 5, and an actuation element 13 cooperating with the piston rod 12, which is activated manually by an operator to activate the parking lock device so that on manual operation of the actuation element 13 by an operator, a control force is applied to the piston rod 12 on the side opposite to the piston unit 5 acting in direction of the piston unit 5 to the shift piston rod 12 together with the piston unit 5 from an axial position A equivalent to the disengaged condition of the locking mechanism or to displace and simultaneously rotate the locking mechanism 3 by a predefined rotation angle from axial position Z equivalent to the engaged condition of the locking mechanism.

Further, on the side opposite to the piston rod 12, the circumference of the piston unit 5 is arranged with a cutoff area 14, illustrated in detail in FIG. 2, that in certain areas extends in a circumference direction which, after activation of the actuation element 13 and starting from the engaged condition of locking mechanism 3 equivalent to the axial position Z, cooperates with the snap-in locking device 8 so that the piston unit 5 is held in the axial position A equivalent to the open condition of the locking mechanism 3 by the snap-in locking device, because said snap-in locking device 8 is activated in the embodiment illustrated in FIG. 1.

Based on the previously disclosed operating condition of the parking lock device 1, a new activation of the actuation element 13 by an operator from the axial position A of the piston unit 5 equivalent to the disengaged condition of locking mechanism 3 rotates the piston rod 12 together with the piston unit 5 against the snap-in locking device 8 so that the snap-in locking device 8 is deactivated, and the piston unit 5 is shifted from the spring device 6 to the axial position Z equivalent to the engaged condition of the locking mechanism 3.

Thereby the snap-in locking device 8 is deactivated by rotating the cut off area 14 in FIG. 2, identified in detail by an arrow P in FIG. 1, by a 45° rotation angle in the direction indicated by a curved arrow D, away from the operating area of the snap-in locking device 8 so that the piston unit 5 can no longer be held by the snap-in locking device 8.

The rotation of the piston rod 12 and the permanently connected piston unit 5 is achieved by axial operation of the actuation element 13 in direction of the piston unit 5. Combined translation and rotation of the piston unit 5 by a defined rotation angle is realized by the especially arranged connection between the piston rod 12 and the actuation element 13. The functional connection between the actuation element 13 and the piston rod 12 additionally discloses the functional principle of a traditional ballpoint pen, where the activation of a pressure element causes the axial and rotational movement of the ballpoint pen refill, whereby the refill is locked in one of the two axial end positions after every activation of the pressure element.

In the parking lock device, according to the present invention, the piston unit 5 is shifted and rotated in axial direction by axial operation of the actuation element 13. Thereby the parking lock device is activated manually by an operator in the direction of the piston unit 5 for emergency unlocking and emergency locking every time, whereby each activation of the actuation element 13 alternatively locks or unlocks the parking lock device.

For this purpose, on its end, cooperating with the actuation element 13, the piston rod 12 is arranged with a transverse milled recess 19 in which an element of the actuation element 13 (not disclosed in detail), engages in a way that an axial displacement of the actuation element 13 causes the axial shift and desired rotation of the piston rod 12 and the connected piston unit 5.

In the present invention actuator 8 is arranged with a spring-mounted detent lever 15 in direction of the piston unit 5, arranged on its front-end facing the piston unit 5 with a beveled guide face 16 over which, on axial displacement of the piston unit 5, the detent lever 15 pivots against the spring tension of an associated spring device 17, thereby pivoting from its position equivalent to the engaged condition of the locking mechanism 3 to the position equivalent to the disengaged condition of the locking mechanism 3.

Further, on its front-end facing the detent lever 15, the piston unit 5 is arranged with a guiding surface 18 over which, on axial displacement of piston unit 5, the detent lever 15 is pivoted against the spring tension of the spring device 17 associated with the detent lever 15, thereby pivoting from its position equivalent to the engaged condition of the locking mechanism to the position equivalent to the disengaged condition of the locking mechanism.

The beveled guide face 16 and the guiding surface 18 cooperate so that, on axial displacement of the piston unit 5, the detent lever 15 is moved with its beveled guide face 16 over the guiding surface 18 against the spring tension of the spring device 17 and is thereby pivoted from the position equivalent to the engaged condition of the locking mechanism 3 to the position equivalent to the disengaged condition of the locking mechanism 3 without causing a blockade between the piston unit 5 and the detent lever 15.

On normal operation, the parking lock device 1 is disengaged by pressurizing the piston unit 5 with a fluid, i.e., pneumatically or hydraulically, in a housing 20, so that the piston unit 5 is displaced from the axial position Z equivalent to the engaged condition of the locking mechanism 3 in direction of the snap-in locking device 8. Thereby the detent lever 15 of the snap-in locking device 8 is pivoted against the spring tension of the spring device 17 from its position equivalent to the engaged condition of the locking mechanism 3 to the position, illustrated in FIG. 1, whereby the cut off area 14 remains in the position, illustrated in FIG. 1, because the piston unit 5 does not rotate on a fluid operation.

As long as the fluid pressure in the housing 20 holds the piston unit 5 in the position unlocking the parking lock device 1, said parking lock device 1 remains disengaged due to the fluid pressure. As this, however, is not desired owing to the loss of efficacy, the fluid pressure in the housing 20 is reduced and the piston unit 5 is shifted in the direction of the actuation element 13 by the spring tension of the spring device 6.

When the electromagnetic actuator 7 is de-energized, the detent lever 15 keeps the piston unit 5 in the position A equivalent to the disengaged condition of the locking mechanism 3, because of the non-positive connection existing between the detent lever 15 and the piston unit 5 due to the active position of the cut off area 14, which keeps the piston unit 5 in a disengaged position.

If locking of the parking lock device is required by an operator or gearbox, the electromagnetic actuator 7, which in the present invention is arranged as a holding magnet, is energized so that the detent lever 15 is pivoted by the piston unit 5 in direction of the electromagnetic actuator 7 so that the non-positive connection between the detent lever 15 and the piston unit 5 is released and the piston unit 5 is displaced by the spring device 6 to the position Z equivalent to the engaged condition of the locking mechanism 3.

According to the invention, the embodiment of the parking lock device disclosed above is characterized by a driver's intuitive operation as with one and the same operation of an emergency mechanism and/or the actuator mechanism 11, he may easily change the condition of the parking lock device between an engaged and/or locked power take-off condition and a disengaged condition, whereby the power take-off rotates freely.

Further, according to the invention, the parking lock device has the advantage that the intended common operative mechanism for the activation of the emergency locking device and emergency unlocking device only requires an outward duct through the housing of the gearbox, which facilitates isolation of the interior of the gearbox from the surrounding areas.

### REFERENCE NUMERALS

1 parking lock device
2 actuator
3 locking mechanism
4 parking lock device rod
5 piston unit
6 spring device
7 electromagnetic actuator
8 snap-in locking device
9 emergency locking device
10 emergency unlocking device
11 actuator mechanism
12 piston rod
13 actuation element
14 cut off area
15 detent lever
16 beveled guide face
17 spring device
18 guiding surface
19 milled recess
20 housing

1-10. (canceled)

11. A parking lock device (1) for a power train of a motor vehicle with an automatic transmission, the device (1) comprising:
a locking mechanism (3) operated by an actuator (2),
the locking mechanism (3) having an engaged condition in which the power take-off of the power train rotationally fixed, and a disengaged condition in which the power take-off of the power train is rotatable;
a piston unit (5) of the actuator (2) engaging the locking mechanism in a normal operation mode of the motor vehicle, when pressurized with a fluid in an engaging direction of the locking device against a spring device (6) which is engaged with the piston unit (5), the piston unit is held in the disengaged position by a snap-in locking device (8) which is controlled by an electromagnetic actuator (7), which fixes the piston unit (5) in an active condition at a first axial position (A) equivalent to the disengaged condition of the locking mechanism (3),
the snap-in locking device (8) is deactivated by the electromagnetic actuator (7);
an emergency locking device (9) manually engages the locking mechanism (3) and an emergency unlocking device (10) disengages the locking mechanism (3); and
a common actuator mechanism (11) operates the emergency unlocking device (10) and the emergency locking device (9) so that manual activation of the actuator mechanism (11) in the same operating direction alternatively disengages or engages the locking mechanism (3).

12. The parking lock device according to claim 11, wherein the actuator mechanism (11) has a piston rod (12) connected to the piston unit (5) and an actuation element (13) cooperates with the piston rod (12) such that an operator can apply a control force to the piston rod (12), on a side opposite the piston unit (5), by way of the actuation element (13), in a direction of the piston unit (5) and shifted axially and simultaneously rotated by a predefined rotation angle together with the piston unit (5) from one of the axial position (A) equivalent to the disengaged condition of the locking mechanism (3) or a second axial position (Z) equivalent to the engaged condition of locking mechanism (3).

13. The parking lock device according to claim 12, wherein after the operation of the actuation element (13) by the operator concludes, the piston rod (12) is displaced by the spring device (6), engaged in the piston unit (5), from the first axial position (A) equivalent to the disengaged condition of the locking mechanism (3) to the second axial position equivalent (Z) to the engaged condition of the locking mechanism (3).

14. The parking lock device according to claim 12, wherein after the operation of the actuation element (13) by the operator concludes, the piston rod (12) is shifted by the spring device (6), engaged in the piston unit (5), from the second axial position (Z) equivalent to the engaged condition of the locking mechanism (3) to the first axial position (A) equivalent to the disengaged condition of the locking mechanism (3).

15. The parking lock device according to claim 12, wherein on an end opposite to piston rod (12) a circumference of the piston unit (5) has a cut off area (14) extending at least in certain areas in a circumference direction, which, after activation of the actuation element (13), starting from a second axial position (Z) equivalent to the engaged condition of the locking mechanism (3) cooperates with the snap-in locking device (3) so that the piston unit (5) is held in the first axial position (A) equivalent to the disengaged condition of the locking mechanism (3) by the snap-in locking device (8).

16. The parking lock device according to claim 15, wherein, after operating the actuation element (13) starting from the first axial position (A) equivalent to the disengaged condition of the locking mechanism (3) of the piston unit (5), the cut off area (14) is rotated in relation to the snap-in locking device (8), so that activation of the snap-in locking device (8) is prevented, and the piston unit (5) is shifted by the spring device (6) to the second axial position (Z) equivalent to the engaged condition of the locking mechanism (3) of the piston unit (5).

17. The parking lock device according to claim 11, wherein the snap-in locking device (8) has a spring-mounted detent lever (15) on an end facing the piston unit (5).

18. The parking lock device according to claim 17, wherein the detent lever (15) has a beveled guide face (16) on the end facing the piston unit (5), over which the detent lever (15) is moved against a spring tension of the spring unit (17), associated with the detent lever (15), on axial displacement of the piston unit (5), and thus is pivoted from the position equivalent to the engaged condition of the locking mechanism (3) to the position equivalent to the disengaged condition of the locking mechanism (3).

19. The parking lock device according to claim 17, wherein the piston unit (5) has a guiding surface (18) on the end facing the detent lever (15), over which the detent lever (15) is moved against the spring tension of the spring unit (17), associated with the detent lever (15), on axial displacement of the piston unit (5), and thus pivoted from the position equivalent to the engaged condition of the locking mechanism (3) to the position equivalent to the disengaged condition of the locking mechanism (3).

20. The parking lock device according to claim 17, wherein the beveled guide face (16) and the guiding surface (18) cooperate such that, on axial displacement of the piston unit (5) against the spring tension of the spring device (17), associated with detent lever (15), the detent lever (15) with the beveled guide face (16) is moved over the guiding surface (18) of the piston unit (5) and thus pivoted from the position equivalent to the engaged condition of the locking mechanism (3) to the position equivalent to the disengaged condition of the locking mechanism (3).
